(19) United States
(12) Patent Application Publication
(10) Pub. No.: US 2024/0413877 A1
(43) Pub. Date: Dec. 12, 2024

(54) Channel State Based Beamforming Enhancement

(71) Applicant: Nokia Solutions and Networks Oy, Espoo (FI)

(72) Inventors: Wenliang Qi, Zhejiang (CN); Chenhui YE, Shanghai (CN); Dani Johannes KORPI, Helsinki (FI); Yuanshang MAO, Shanghai (CN); Ruiling ZHAO, Shanghai (CN)

(21) Appl. No.: 18/702,589

(22) PCT Filed: Oct. 20, 2021
(86) PCT No.: PCT/CN2021/124971

§ 371 Date: Apr. 18, 2024

(51) Int. Cl. H04B 7/06

(52) U.S. Cl. CPC H04B 7/06952; H04B 7/0626

(57) ABSTRACT

Example embodiments of the present disclosure relate to channel state based beamforming enhancement. A first device receives, from a second device, a second message indicating a second channel state. The second message has a second length less than a first length of a first message indicating a first channel state previously received from the second device. The first device obtains combined beamforming features of the second device according to a trained combining model associated with the second device and based on the second message and historical beamforming features of the second device. The first device generates a beam weight for the second device according to a trained beamforming model and based on the combined beamforming features. The first device may generate a beam weight for the second device according to the beamforming model without recovering CSI from the message.

### FIELD

Embodiments of the present disclosure generally relate to the field of telecommunication and in particular, to methods, devices, apparatuses and computer readable storage medium for channel state based beamforming enhancement.

### BACKGROUND

In communication systems, multiple antenna techniques have been widely used to expand a system capacity and improve the system performance. Multiple antennas may result in a multiple-input multiple-output (MIMO) communication channel. In order to improve signal quality and reduce interference in the MIMO communication channel, beamforming techniques have been used. In recent communication technologies, it has been proposed to perform beamforming based on channel characteristics such as channel state. Works are ongoing to introduce enhancements to channel state based beamforming, particularly for downlink (DL) MIMO beamforming, to improve transmission performance.

### SUMMARY

The scope of protection sought for various embodiments of the invention is set out by the independent claims. The embodiments/examples and features, if any, described in this specification that do not fall under the scope of the independent claims are to be interpreted as examples useful for understanding various embodiments of the invention.” Please note that the term “embodiments” or “examples” should be adapted accordingly to the terminology used in the application, i.e. if the term “examples” is used, then the statement should talk of “examples” accordingly, or if the term “embodiments” is used, then the statement should talk of “embodiments” accordingly.

In general, example embodiments of the present disclosure provide a solution for channel state based beamforming enhancement. Embodiments that do not fall under the scope of the claims, if any, are to be interpreted as examples useful for understanding various embodiments of the disclosure.

In a first aspect, there is provided a first device. The first device comprises at least one processor; and at least one memory including computer program code; where the at least one memory and the computer program code are configured to, with the at least one processor, cause the first device to receive, from a second device, a second message indicating a second channel state, a second length of the second message being less than a first length of a first message indicating a first channel state previously received from the second device; obtain combined beamforming features of the second device according to a trained combining model associated with the second device and based on the second message and historical beamforming features of the second device; and generate a beam weight for the second device according to a trained beamforming model and based on the combined beamforming features.

In a second aspect, there is provided a second device. The second device comprises at least one processor; and at least one memory including computer program code; where the at least one memory and the computer program code are configured to, with the at least one processor, cause the second device to determine a second message indicating a second channel state according to a trained compression model, the second message having a second length less than a first length of a first message indicating a first channel state, the first message being previously determined by the second device; and transmit, to a first device, the second message.

In a third aspect, there is provided a fourth device. The fourth device comprises at least one processor; and at least one memory including computer program code; where the at least one memory and the computer program code are configured to, with the at least one processor, cause the fourth device to generate a second message according to a compression model for a second device, the second message indicating a second channel state, the second message having a second length less than a first length of a first message generated previously, the first message indicating a first channel state; obtain combined beamforming features of the second device according to a combining model for a first device associated with the second device and based on the second message and historical beamforming features of the second device; generate a beam weight for the second device according to a beamforming model for the first device based on the combined beamforming features; and train the compression model, the combining model and the beamforming model based on the beam weight.

In a fourth aspect, there is provided a method. The method comprises receiving, by a first device and from a second device, a second message indicating a second channel state, a second length of the second message being less than a first length of a first message indicating a first channel state previously received from the second device; obtaining combined beamforming features of the second device according to a trained combining model associated with the second device and based on the second message and historical beamforming features of the second device; and generating a beam weight for the second device according to a trained beamforming model and based on the combined beamforming features.

In a fifth aspect, there is provided a method. The method comprises determining, by a second device, a second message indicating a second channel state according to a trained compression model, the second message having a second length less than a first length of a first message indicating a first channel state, the first message being previously determined by the second device; and transmitting, to a first device, the second message.

In a sixth aspect, there is provided a method. The method comprises generating a second message according to a compression model for a second device, the second message indicating a second channel state, the second message having a second length less than a first length of a first message generated previously, the first message indicating a first channel state; obtaining combined beamforming features of the second device according to a combining model for a first device associated with the second device and based on the second message and historical beamforming features of the second device; generating a beam weight for the second device according to a beamforming model for the first device based on the combined beamforming features; and training the compression model, the combining model and the beamforming model based on the beam weight.

In a seventh aspect, there is provided a first apparatus. The first apparatus comprises means for receiving, from a second apparatus, a second message indicating a second channel state, a second length of the second message being less than a first length of a first message indicating a first channel state previously received from the second apparatus; means for obtaining combined beamforming features of the second apparatus according to a trained combining model associated with the second apparatus and based on the second message and historical beamforming features of the second apparatus; and means for generating a beam weight for the second apparatus according to a trained beamforming model and based on the combined beamforming features.

In an eighth aspect, there is provided a second apparatus. The second apparatus comprises means for determining a second message indicating a second channel state according to a trained compression model, the second message having a second length less than a first length of a first message indicating a first channel state, the first message being previously determined by the second apparatus; and means for transmitting, to a first apparatus, the second message.

In a ninth aspect, there is provided a fourth apparatus. The fourth apparatus comprises means for generating a second message according to a compression model for a second apparatus, the second message indicating a second channel state, the second message having a second length less than a first length of a first message generated previously, the first message indicating a first channel state; means for obtaining combined beamforming features of the second apparatus according to a combining model for a first apparatus associated with the second apparatus and based on the second message and historical beamforming features of the second apparatus; means for generating a beam weight for the second apparatus according to a beamforming model for the first apparatus based on the combined beamforming features; and means for training the compression model, the combining model and the beamforming model based on the beam weight.

In a tenth aspect, there is provided a computer readable medium. The computer readable medium comprises program instructions for causing an apparatus to perform any of the fourth, the fifth and the sixth aspects.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a block diagram of an example for channel state based beamforming;

FIG. 3 illustrates a block diagram of example architecture for channel state based beamforming in accordance with some embodiments of the present disclosure;

FIG. 4A illustrates an example compression model in accordance with some embodiments of the present disclosure;

FIG. 4B illustrates an example combining model in accordance with some embodiments of the present disclosure;

FIG. 4C illustrates an example beamforming model in accordance with some embodiments of the present disclosure;

FIG. 5 illustrates a block diagram of example training architecture for channel state based beamforming in accordance with some embodiments of the present disclosure;

FIG. 6 illustrates a signaling chart showing an example process of beamforming according to some example embodiments of the present disclosure;

FIG. 7 illustrates a signaling chart showing an example process of finetuning models according to some example embodiments of the present disclosure;

FIG. 8 illustrates a signaling chart showing an example process of adjusting length information according to some example embodiments of the present disclosure;

FIG. 9A illustrates a chart illustrating efficiency at different timeslots using the beamforming approach and using several convention approaches according to the present disclosure;

FIG. 9B illustrates another chart illustrating efficiency at different timeslots using the beamforming approach and using several convention approaches according to the present disclosure;

FIG. 10 illustrates a flowchart of a method implemented at a first device according to some example embodiments of the present disclosure;

FIG. 11 illustrates a flowchart of a method implemented at a second device according to some example embodiments of the present disclosure;

FIG. 12 illustrates a flowchart of a method implemented at a fourth device according to some example embodiments of the present disclosure;

FIG. 13 illustrates a simplified block diagram of an apparatus that is suitable for implementing example embodiments of the present disclosure; and

FIG. 14 illustrates a block diagram of an example computer readable medium in accordance with some example embodiments of the present disclosure.

Throughout the drawings, the same or similar reference numerals represent the same or similar element. Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, a resource in both frequency domain and time domain will be used as an example of a transmission resource for describing some example embodiments of the present disclosure. It is noted that example embodiments of the present disclosure are equally applicable to other resources in other domains.

As briefly mentioned above, multiple antenna techniques have been widely used to provide MIMO communication channels to expand a system capacity and improve the system performance. It may use channel state based beamforming to improve signal quality and reduce interference in the MIMO communication channels

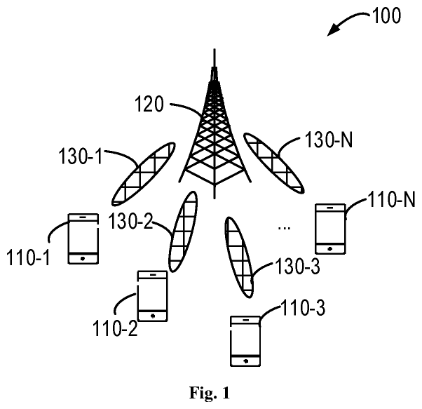

FIG. 1 shows an example communication environment 100 in which example embodiments of the present disclosure can be implemented. In the communication environment 100, a plurality of communication devices, including a device 110-1, a device 110-2, a device 110-3, . . . , and a device 110-N, may communicate with a device 120. For ease of discussion, the devices 110-1, 110-2, 110-3, . . . , and 110-N may be collectively referred to as “devices 110” or individually referred to as a “device 110”. In the example of FIG. 1, the device 120 is illustrated as a network device, while the devices 110 are illustrated as terminal devices connected to the device 120.

In the communication environment 100, the device 120 has a certain coverage range, which may be called as a serving area or a cell. The devices 110 are located in the cell provided by the device 120. In the communication network 100, the device 120 may communicate data and control information to the device 110 and the device 110 may also communication data and control information to the device 120. A link from the device 120 to the device 110 is referred to as a downlink (DL) or a forward link, while a link from the device 110 to the device 120 is referred to as an uplink (UL) or a reverse link.

The devices 110 may transmit resource requests (RRs) to the device 120. The device 120 may select one or more devices from the devices 110 to provide resources. For example, as illustrated in FIG. 1, the devices 110 may choose the device 110-1, the device 110-2 and the device 110-N to provide resources. These devices may also be referred to as active devices. In some example embodiments, the device 120 may determine not to provide resources for several devices such as the device 110-3, which may also be referred to as an inactive device. It is to be understood that the active devices and the inactive devices may be changeable. For example, in the case that the device 110-3 is determined as the inactive device at an initial timeslot, the device 110-3 may become an active device in a subsequent timeslot after the initial timeslot.

The device 120 may provide a plurality of beams for the active devices. For example, the device 110-1 is associated with a beam 130-1, the device 110-2 is associated with a beam 130-2, while the device 110-N is associated with a beam 130-N. At the subsequent timeslot, the device 120 may provide a beam 130-3 for the device 110-3. For ease of discussion, the beams 130-1, 130-2, 130-3 and 130-N may be collectively referred to as “beams 130” or individually referred to as a “beam 130”.

In some example embodiments, the device 120 may determine the plurality of beams 130 for the active devices based on channel characteristics such as channel state of those active devices. For example, the device 120 may determine the beam 130-1 for the device 110-1 based on a channel state of the device 110-1. With the beams 130, the device 120 may perform a transmission with the active devices via the beams 130. For example, the device 120 may transmit a DL transmission to the device 110-2 via the beam 130-1.

It is to be understood that the number of devices and their connections shown in FIG. 1 are only for the purpose of illustration without suggesting any limitation. The environment 100 may include any suitable number of devices adapted for implementing embodiments of the present disclosure. Although not shown, it would be appreciated that one or more additional devices may be located in the cell provided by the device 120, and one or more additional cells may be deployed in the environment 100.

Communications in the communication environment 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

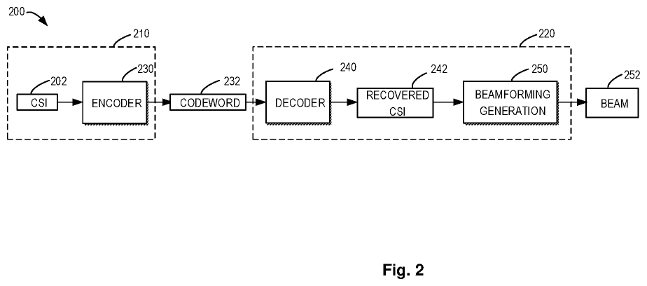

Conventionally, the network device may perform the beamforming based on CSI received from the network device. FIG. 2 illustrates a block diagram 200 of an example channel state based beamforming.

As shown in FIG. 2, a terminal device 210 measures CSI 202. An encoder 230 of the terminal device 210 encodes or compresses the CSI 202 into a codeword 232. The terminal device 210 may additionally quantize the codeword 232 into a quantized codeword. The terminal device 210 transmits the codeword 232 (or the quantized codeword) to a network device 220 via an air interface. The network 220 receives the codeword 232 and decodes the codeword 232 by a decoder 240 into a recovered CSI 242. If the network receives the quantized codeword, the network device 220 may additional dequantize the quantized codeword to obtain the codeword 232. The network device 250 uses the recovered CSI to perform beamforming generation 250 to obtain a beam 252 for the terminal device 210.

The above described approach uses the recovered CSI for beamforming. This approach is oriented to CSI recovery, instead of oriented to the beamforming. This kind of CSI recovery oriented beamforming is under satisfying in either limited performance gain due to the inaccuracy of CSI or intensive overheads in an air interface. For example, it may lead to coarse beams due to low resolution CSI. By contrast, if providing higher resolution CSI, then this approach may bring high cost of denser codeword overheads. Gain of the beams generated by this approach is less than expected. The beams cannot intelligently adapt to various conditions. Thus, performance with the beams generated based on the recovered CSI for both DL MIMO and CSI-bit expenditure is unsatisfying.

To solve this above mentioned problem, it has been proposed to improve accuracy in the CSI recovery, for example by applying adaptive nonlinear feature extraction and compression (such as an autoencoder neural network (NN) model) in the terminal device and by improving recovery ability in the network device. For example, autoencoder NN may be adjusted by comparing the CSI 202 and the recovered CSI 242. Although this approach may reduce overheads, however, beamforming quality is still unsatisfying because the beamforming quality is not completely dependent on the precision of the CSI recovery. In addition, this recovery-oriented CSI feedback approach is targeting at single user (SU) scope, but fails to consider multi-user (MU) scenarios. Moreover, this recovery-oriented CSI feedback approach fails to consider time-adaptive beamforming, thus frequency CSI-feedback over coherent time leads to feedback redundancy, especially in mobile scenarios.

It has been proposed to use instantaneous frequency-spatial CSI compression for static scenarios. This approach may improve CSI feedback accuracy and reduce overheads by compressed CSI feedback via uplink. However, such approach is also limited to static scenarios and SU cases.

It has also been proposed to use sequential frequency-spatial-time CSI feedback in dynamic scenarios. This approach considers correlation between consecutive CSIs and may improve performance in dynamic case. However, such approach is still not beamforming oriented, and such approach may result in non-optimal performance and redundancy. Likewise, such approach is also limited to SU cases, without jointly consideration of MU cases.

As discussed above, it is challenging to enhance the channel state based beamforming, particularly in MU scenarios. According to some example embodiments of the present disclosure, there is provided a solution for the channel state based beamforming enhancement for DL transmission. In this solution, a first device receives a message indicating a channel state from a second device. The message has a length shorter than a length of a previously received message. The first device obtains combined beamforming features of the second device according to a trained combining model and based on the message and historical beamforming features of the second device. The first device generates a beam weight for the second device according to a trained beamforming model and based on the combined beamforming features. The first device may perform a transmission via a beam formed with the beam weight.

This solution enables the first device to generate a beam weight according to the trained beamforming model and based on the message indicating the channel state and the historical beamforming features of the second device. Such approach is beamforming oriented, which does not require the CSI recovery. Such approach directly aiming at the optimized beamforming matrices in a supervised learning is more favorable to enhance the DL MIMO transmission. In addition, such approach considers the historical beamforming features of the second device, which will improve the performance especially in mobile scenarios.

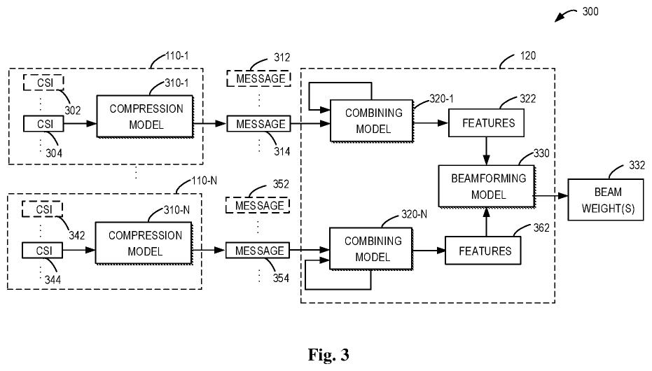

The example embodiments of the present disclosure will be described in detail below with reference to FIGS. 3-14.

FIG. 3 illustrates a block diagram of example architecture 300 for channel state based beamforming in accordance with some embodiments of the present disclosure. It is to be understood that the architecture 300 shown in FIG. 3 is only for the purpose of illustration, without suggesting any limitation to functions and the scope of the embodiments of the present disclosure. According to FIG. 3, the architecture 300 includes the device 110-1, . . . , the device 110-N and the device 120.

It is to be understood that the number of devices and their connections shown in FIG. 3 are only for the purpose of illustration without suggesting any limitation. The architecture 300 may include any suitable number of devices adapted for implementing embodiments of the present disclosure. For example, the architecture 300 may include only one device 110 and the device 120. The architecture 300 may also include more than two devices 110 and the device 120.

As shown in FIG. 3, the device 110-1 includes a compression model 310-1. The compression model 310-1 may receive CSI 304 and output a message 314. For example, the device 110-1 may measure the CSI 304 and input the CSI 304 to the compression model 310-1. The compression model 310-1 may also previously receive CSI 302, and process the CSI 302 to obtain a message 312. It is to be understood that the compression model 310-1 may receive additional CSI before or after the CSI 302.

In some example embodiments, the message 312 and the message 314 may be codewords, such as codewords according to a predefined codebook. Alternatively, the message 312 and the message 314 may be other suitable vectors comprising information obtained from the CSI 302 and the CSI 304 respectively. In some example embodiments, a length (or a bit width) of the message 314 may be shorter than a length of the message 312. The length of the message 314 and the length of the message 312 may be predefined or adjusted.

Likewise, the device 110-N includes a compression model 310-N which receives CSI 344 and outputs a message 354. The compression model 310-N may also previously received CSI 342 and output a message 252. For ease of discussion, the compression models 310-1, . . . , and 310-N may be collectively referred to as “compression models 310” or individually referred to as a “compression model 310”.

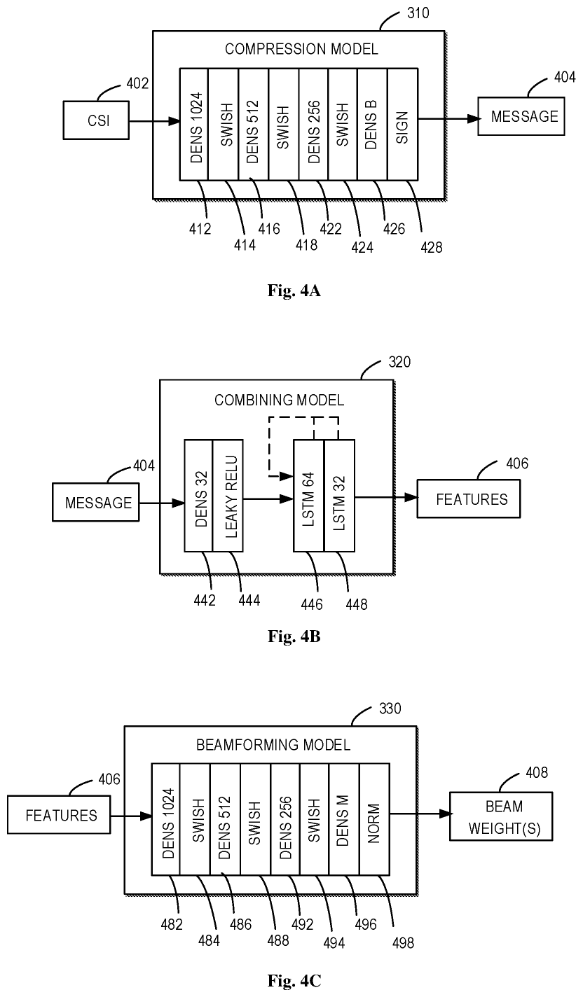

FIG. 4A illustrates an example compression model 310 in accordance with some embodiments of the present disclosure. As shown in FIG. 4A, the compression model 310 receives CSI 402 and processes the CSI 402 to obtain a message 404. The compression model 310 may comprise several fully connected (FC) layers. For example, in the example of FIG. 4A, the compression model 310 comprises a dense 1024 layer 412, a swish layer 414, a dense 512 layer 416, a swish layer 418, a dense 256 layer 422, a swish layer 424, a dense B layer 426 and a sign layer 428. The number “B” of the dense B layer 426 represents an output dimension of the dense B layer 426, i.e., the length of the message 404.

In some example embodiments, the number “B” may be adaptive. For example, the number “B” may be adjusted according to the device 110. For example, in a first time period, the number “B” may be set as a bigger number such as 10. In a second time period after the first time period, the number “B” may be set as a smaller number such as 3. By doing so, the length of the message 404 may be adjusted accordingly. Thus, overheads in air interface may be reduced. It is to be understood that the numbers of 10 and 3 are only for the purpose of illustration without suggesting any limitations. It is to be understood that the compression model 310 shown in FIG. 4A is only for the purpose of illustration. Any suitable neural network model can be used to implement the compression 310.

Referring back to FIG. 3, the device 110-1 transmits the message 314 to the device 120. For example, the device 110-1 may transmit the message 314 to the device 120 via physical uplink (UL) shared channel (PUSCH) or physical UL control channel (PUCCH). The device 120 includes a combining model 320-1 which receives the message 314. The combining model 320-1 may obtain combined beamforming features 322 of the device 110-1 based on the message 312 and historical beamforming features of the device 110-1. For example, the historical beamforming features of the device 110-1 may be obtained based on the message 312 previously received by the combining model 320-1. The combining model 320-1 may also update the historical beamforming features to be the combined beamforming features 322 for following usage.

In some example embodiments, the combining model 320-1 may extract current CSI features based on the message 314 and obtain the historical beamforming features from its storage. The combining model 320-1 may obtain the combined beamforming features 322 by bits concatenation of the current CSI features and the historical beamforming features. The combining model 320-1 may also obtain the combined beamforming features 322 by using any other suitable method.

Likewise, the device 120 may also include a combining model 320-N which receives message 354 and obtains combined beamforming features 362 of the device 110-N based on the message 354 and historical beamforming features of the device 110-N. Similarly, the historical beamforming features of the device 110-N may be obtained based on the message 352 previously received by the combining model 320-N. For ease of discussion, the combining models 320-1, . . . , and 320-N may be collectively referred to as “combining models 320” or individually referred to as a “combining model 320”. It is to be understood that although different combining models 320 correspond to different devices 110 as shown in FIG. 3, the device 120 may also include only one combining model 320. The device 120 may use one combining model 320 to receive and process messages from different devices 110.

FIG. 4B illustrates an example combining model 320 in accordance with some embodiments of the present disclosure. As shown in FIG. 4B, the combining model 320 receives the message 404 and processes the message 404 to obtain combined beamforming features 406. The combining model 320 may comprise a FC layer such as a dense 32 layer 442 with LeakyReLU activation function 444 and two stacked Long-short term memory (LSTM) layers such as a LSTM 64 layer 446 and a LSTM 32 layer 448.

The dense 32 layer 442 may be used to extract CSI features. The LSTM 64 layer 446 and the LSTM 32 layer 448 may obtain combined beamforming features 406 based on the extracted CSI features and historical beamforming features stored in the combining model 320. If there is no historical beamforming features stored in the combining model 320, the combining model 320 may determine the extracted CSI features as the combined beamforming features 406 and store the extracted CSI features as the historical features. The combining model 320 may also update the historical features after obtaining new combined beamforming features for a next timeslot.

By storing the historical beamforming features in the device 120, it may use a message with a shorter length in a following timeslot to represent an incremental or delta of following CSI. In addition, considering the historical beamforming features may further improve the beamforming performance especially in dynamic scenarios. It is to be understood that the combining model 320 shown in FIG. 4B is only for the purpose of illustration. Any suitable neural network model can be used to implement the combining model 320.

Still in reference with FIG. 3, the device 120 includes a beamforming model 330. The beamforming model 330 receives the combined beamforming features 322 from the combining model 320-1. The beamforming model 330 may also receive the combined beamforming features 362 from the combining model 320-N. In the example where the device 120 use one combining model 320 to obtain the combined beamforming features 322 and the combined beamforming features 362, the combining model 320 may combine the combined beamforming features 322 and the combined beamforming features 362 into MU beamforming features. The combining model 320 may transmit the MU beamforming features to the beamforming model 330.

The beamforming model 330 may generate a beam weight for the device 110-1 based on the combined beamforming features 322. Alternatively, or in addition, the beamforming model 330 may generate beam weight(s) for the device 110-1 and the device 110-N based on the combined beamforming features 322 and the combined beamforming features 362. The beamforming model 330 may also generate a set of beam weights for a set of devices including the device 110-1 and the device 110-N based on a set of combined beamforming features of the set of devices. The beam weight 332 may be in a form of a beam matrix, a beam vector or other suitable form. The first device 120 may apply the beam weight 332 for DL transmission such as DL MIMO transmission. For example, the device 120 may perform a DL transmission to the device 110-1 via a beam formed based on the beam weight 332 for the device 110-1.

FIG. 4C illustrates an example beamforming model 330 in accordance with some embodiments of the present disclosure. As shown in FIG. 4C, the beamforming model 330 receives the features 406 and processes the features 406 to obtain beam weight(s) 408. The beamforming model 330 may comprise several FC layers. For example, in the example of FIG. 4C, the beamforming model 330 comprises a dense 1024 layer 482, a swish layer 484, a dense 512 layer 486, a swish layer 488, a dense 256 layer 492, a swish layer 494, a dense M layer 496 and a norm layer 498.

The number “M” of the dense M layer 496 represents an output dimension of the dense M layer 496. In some example embodiments, the number “M” is equal to K×Nₜ, wherein K represents the number of active devices, and Nₜ represents the number of antennas at the device 120. The beamforming model 330 may output K beam weights to K devices. Each beam weight has a dimension of Nₜ. Each dimension of each beam weight may be a complex value.

Alternatively, the number “M” of the dense M layer 496 may be equal to 2×K×Nₜ. In this case, each dimension of each beam weight may comprise a real part of a complex value and an imaginary part of the complex value. It is to be understood that the compression model 310 shown in FIG. 4A is only exemplary. Any suitable neural network model can be used to implement the compression model 310.

Example embodiments of channel state based beamforming according to the present disclosure have been described above. Such beamforming oriented approach may enhance the DL transmission particularly for the DL MIMO transmission. Such approach considers the historical beamforming features, thus can be benefit for the dynamic scenarios. In addition, the overheads may be reduced by adapting the length of the message. In addition, such approach also jointly considers the beamforming features of MU which will improve performance in the MU scenarios.

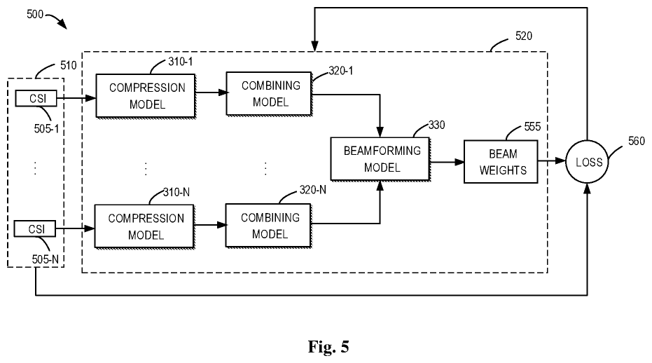

In some example embodiments, the compression model 310, the combining model 320 and the beamforming model 330 may be pre-trained before being applied. FIG. 5 illustrates a block diagram of example training architecture 500 for training the compression model 310, the combining model 320 and the beamforming model 330 in accordance with some embodiments of the present disclosure.

It is to be understood that the number of models and their connections shown in FIG. 5 are only for the purpose of illustration without suggesting any limitation. The architecture 500 may include any suitable number of models adapted for implementing embodiments of the present disclosure. For example, the architecture 500 may include only one compression model 310 and only one combining model 320. The architecture 500 may also include more than two compression models 310 and combining models 320. The architecture 500 may also include more than one beamforming model 330.

The compression models 310 may be applied to a group of terminal devices after training. For example, the compression model 310 may be applied to an intended device such as the device 110 after training. The term of “intended device” may be referred to the device that the compression model 310 may be applied to after training. For example, the compression model 310-1 may be applied to the device 110-1 after training, and the compression model 310-N may be applied to the device 110-N after training. Similarly, the combining models 320 and the beamforming model 330 may be applied to a network device such as the device 120 after training.

As shown in FIG. 5, input CSI sequences 510 including CSI sequence 505-1, . . . and CSI sequence 505-N may be used to train a group of models 520. The group of models 520 comprises compression model 310-1, . . . , the compression model 310-N, the combining model 320-1, . . . , the combining model 320-N and the beamforming model 330. In some example embodiments, the input sequences CSI 510 may be obtained by collecting real CSI from several terminal devices during a predefined period of time. Data augmentations such as randomly deleting or inserting pseudo CSI in the real CSI may also be applied to generate the input sequences CSI 510. Alternatively, or in addition, the input CSI sequences 510 may be generated randomly by using for example a channel model. The CSI sequence 505-1 and the CSI sequence 505-N may be the same or be different. The time interval between CSI in each CSI sequence 505 may be predefined. The total number of CSI in each CSI sequence 505 may be predefined.

In some example embodiments, lengths of each CSI in the CSI sequence 505-1 or the CSI sequence 505-N may be adaptive. For example, the initial CSI in the CSI sequence 505-1 or the CSI sequence 505-N may have a larger length such as 10 bits. The following CSI in the CSI sequence 505-1 or the CSI sequence 505-N may have a less length such as 3 bits. For another example, the initial three CSI in the CSI sequence 505-1 or the CSI sequence 505-N may have a larger length such as 8 bits. The following five CSI in the CSI sequence 505-1 or the CSI sequence 505-N may have a less length such as 5 bits. It is to be understood the example lengths and length pattern are only shown for the purpose of illustration without suggesting any limitations.

In the example of FIG. 5, the compression model 310-1 may receive and process the CSI sequence 505-1. The compression model 310-1 may generate a corresponding message sequence and transmit the corresponding message sequence to the combining model 320-1. For example, the compression model 310-1 may receive the initial CSI in the CSI sequence 505-1 and generate a first message indicating the initial CSI. The first message may have a larger length such as 10 bits. The compression model 310-1 may transmit the first message to the combining model 320-1.

The compression model 310-1 may receive the following CSI in the CSI sequence 505-1. The compression model 310-1 may generate a second message indicating the following CSI based on a difference between the following CSI and the initial CSI. The second message may have a length such as 3 bits. By using similar process, the compression model 310-1 may generate the message sequence based on the CSI sequence 505-1.

The combining model 320-1 may receive the message sequence from the compression model 310-1. The combining model 320-1 may process the message sequence to obtain a corresponding sequence of combined beamforming features. For example, the combining model 320-1 may receive the first message and extract features from the first message. As mentioned above, the first message may have the length of 10 bits. The combining model 320-1 may determine historical beamforming features of the device 110-1 as the features extracted from the first message. The combining model 320-1 may obtain first combined beamforming features as the features extracted from the first message.

The combining model 320-1 may receive the second message following the first message. As above mentioned, the second has the length of 3 bits. The combining model 320-1 may obtain second combined beamforming features based on the second message and the historical beamforming features. The combining model 320-1 may also update the historical beamforming features based on the second combined beamforming features. By using similar process, the combining model 310-2 may obtain a sequence of the combined beamforming features corresponding to the CSI sequence 505-1. The combining model 320-1 may transmit the corresponding sequence of combined beamforming features to the beamforming model 330.

Likewise, the compression model 310-N may receive and process the CSI sequence 505-N. The compression model 310-N may generate a corresponding message sequence and transmit the corresponding message sequence to the combining model 320-N. The combining model 320-N may receive and process the message sequence to obtain a corresponding sequence of combined beamforming features. The combining model 320-N may transmit the corresponding sequence of combined beamforming features to the beamforming model 330.

The beamforming model 330 may receive the sequences of the combined beamforming features from different combining models 320. The beamforming model 330 may generate a sequence of beam weights 555 based on those sequences of the combined beamforming features. For example, the beamforming model 330 may generate a second beam weight based on the second combined beamforming features. The sequence of beam weights may be input to a loss module 560. Thus, the compression models 310, the combining models 320 and the beamforming model 330 may be trained based on the sequence of the beam weights. For example, the compression models 310, the combining models 320 and the beamforming model 330 may be trained based on the second beam weight.

In some example embodiments, the loss module 560 generates beamforming gain for the intended device such as the device 110-1 based on the sequence of beam weights of the device 110-1 and the CSI sequence of the device 110-1. The loss module 560 may determine interference between the device and another device such as the device 110-N communicating with the device 120 based at least on the sequence of beam weights for the device 110-N and the CSI sequence for the device 110-1. The loss module 560 may determine parameters of the compression model 310-1, the combining model 320-1 and the beamforming model 330 based on a comparison between the beamforming gain and the interference.

Alternatively, or in addition, in some example embodiments, the loss module 560 may determine its loss function [symbol] as below:

$$ℒ = - {\sum }_{t = 0}^{T} {ℛ}_{t} \qquad ( 1 )$$

where t denotes the timeslot in the input CSI sequences 510, T denotes the number of continuous timeslots in training phase, [symbol] ₜ denotes the weighted gross throughput of all the intended devices at the timeslot t.

In some embodiment, [symbol] ₜ may be calculated as follows:

$${ℛ}_{t} = {\sum }_{k = 1}^{K} {α}_{k} {log}_{2} ( 1 + \frac{{\vert {h}_{k}^{t} {v}_{k}^{t} \vert}^{2}}{{\sum }_{j \neq k} {\vert {h}_{k}^{t} {v}_{j}^{t} \vert}^{2} + {σ}^{2}} ) \qquad ( 2 )$$

where hₖ^{t} denotes the measured CSI of the intended device k at the timeslot t, vₖ^{t} denotes the beamforming weights of the intended device k at the timeslot t, αₖ denotes the priority weight of the intended device k, σ is the average noise power. The priority weight a may be predefined, while the average noise power σ may be measured. The numerator hₖ^{t}vₖ^{t} represents the gain from generated beam weights,

$${\sum }_{j \neq k} {\vert {h}_{k}^{t} {v}_{j}^{t} \vert}^{2}$$

represents leakage of interference from other user beams. Using such loss function, the training of the group of models 520 is targeted at comprehensively higher beamforming gain and lower interference from other users, generating beam weights for all users in a period of time.

By using the above described loss function, both time correlation and interference are considered jointly and centrally by the network device. Such approach can both improve the beamforming performance of the beamforming model and also reduce CSI overheads by training the compression model(s), the combining model(s) and the beamforming model.

In some example embodiments, the priority weights a of each intended device may be adjusted. The loss function is calculated according to above equations (1) and (2) based on input CSI sequences 510 and output sequence of beam weights 555. The compression models 310-1, . . . , and 310-N, the combining models 320-1, . . . , and 320-N and the beamforming model 330 will be updated via backpropagation. By updating these models, it may optimize the beams with different targets. For example, it may optimize overall throughputs for all users, or optimize throughput for a certain user. In this way, the trained beamforming model can generate optimized beam weights for MU. In addition, the trained compression model may further reduce the CSI overheads.

It is to be understood that the above network structure and processing for training those models are merely examples. The protection scope of the present disclosure is not limited in this regard.

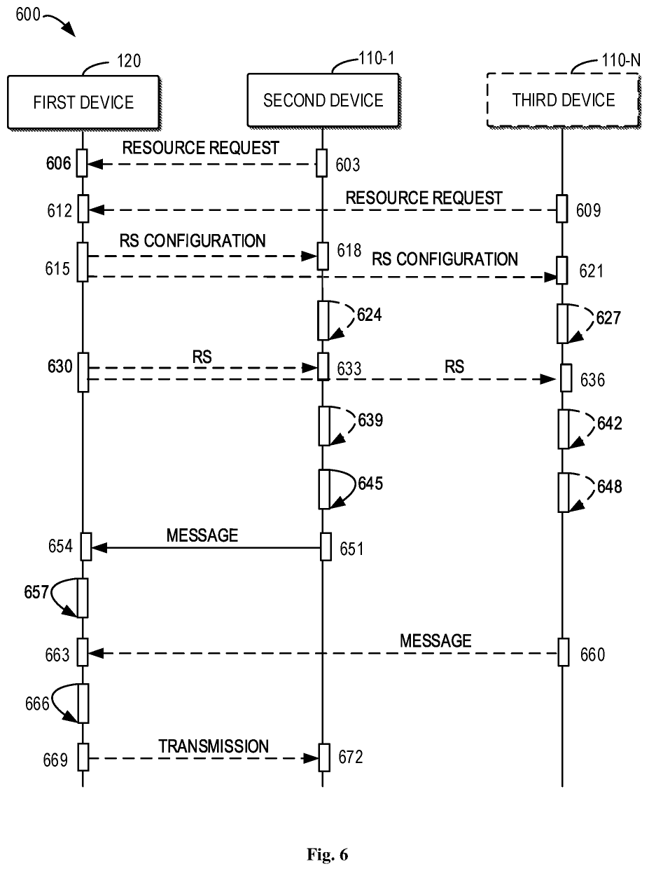

The training process for the compression model, the combining model and the beamforming model has been described above with respect to FIG. 5. In application, these models may also be finetuned to further improve their performance. The application of these models and the finetuning process of those models will be described below with respect to FIGS. 6-8.

FIG. 6 shows a signaling chart 600 illustrating an example process of channel state based beamforming according to some example embodiments of the present disclosure. For the purpose of discussion, the signaling chart 600 will be described with reference to FIGS. 1 and 3. As shown in FIG. 6, the signaling chart 600 involves the device 120, the device 110-1 and optional the device 110-N. As used hereinafter, the device 120 may be also referred to as a first device. The device 110-1 may also be referred to as a second device. The device 110-N may also be referred to as a third device. For the purpose of discussion, there are three devices illustrated in FIG. 6. It is to be understood that the signaling chart 600 may involves more devices or less devices, and the number of devices illustrated in FIG. 6 is only for the purpose of illustration without suggesting any limitations.

In operations, the device 110-1 may transmit 603 a resource request to the device 120. Other devices such as the device 110-N may also transmit 609 a resource request to the device 120. The device 120 receives 606/612 the resource request(s) from several devices. The device 120 may select one or more devices from those devices transmitting the resource request(s) as active device(s). For example, the device 120 may select the device 110-1 as the active device. For another example, the device 120 may choose a group of devices (for example the device 110-1 and the device 110-N) as the active devices. For a further example, the device 120 may select a predetermined number K of devices as the active devices ({device 1, device 2, . . . , device K}). The device 120 may select the active device(s) randomly or according to predefined rules such as based on positions.

The device 120 may transmit 615 reference signal (RS) configuration information to the active device(s). For example, in the scenario that the device 110-1 is the active device, the device 120 may transmit 615 the RS configuration information to the device 110-1. In the scenarios that the group of devices such as the device 110-1 and the device 110-N are active devices, the device 120 may transmit 615 the RS configuration information to the devices 110-1 and 110-N.

The RS configuration information may comprise RS type, feedback period &t, etc. The RS type may comprise CSI-RS or demodulation RS(s) (DMRS(s)) or other suitable RS type. The feedback period St represents the interval of timeslot for CSI report. It is to be understood that the feedback period 8t may be different from different devices 110. The device 110-1 and optional the device 110-N may receive 618/621 the RS configuration information from the device 120. The device 110-1 and optional the device 110-N may transmit message(s) indicating a channel state to the device 120 at different timeslots with the feedback period 8t, which will be described below.

The device 110-1 may determine 624 length information for a message indicating a channel state of the device 110-1. The length information may comprise a large length

B₁ and a short length Bₛ. The large length B₁ and the short length Bₛ may be determined based on the received RS configuration information. Alternatively, the large length B₁ and the short length Bₛ may be determined based on historical data of CSI. The message generated by the device 110-1 may have the large length B₁ or the short length Bₛ.

Alternatively, or in addition, the length information may further comprise repeat times UF_{B1} of the large length B₁ and repeat times UF_{Bs} of the short length Bₛ. For example, if B₁ equates 10 bits, Bₛ equates 3 bits, UF_{B1} equates 2 and UF_{Bs} equates 5, then the device 110-1 may generate a sequence of messages with length of 10 bits, 10 bits, 3 bits, 3 bits, 3 bits, 3 bits and 3 bits, respectively. It is to be understood that the example numbers of B₁, Bₛ, UF_{B1} and UF_{Bs} are only for the purpose of illustrations without suggesting any limitations.

In some example embodiments, the length information may comprise further information, such as a pattern of message length variations. The information may comprise one or more further lengths other than the large length B₁ and the short lengthBₛ. The device 110-1 may generate the message(s) based on the length information. The device 110-N may determine 627 length information as well. The length information of the device 110-N and the length information of the device 110-1 may be different. In this way, the bit length of message(s) will vary from report to report, thus reduce the overheads.

The device 110-1 and the device 110-N may transmit the length information to the device 120, respectively. Alternatively, in some example embodiments, the length information may be predetermined by the device 120 and transmit to the device 110. In this way, the length information of messages will be coordinated between the device 120 and the device 110.

The device 120 may transmit 630 RS to the device 110-1 and optionally the device 110-N. In some example embodiments, the device 120 may transmit 630 the RS(s) to the device 110-1 periodically. For example, the device 120 may transmit CSI-RS(s) to the device 110 at different timeslot with the feedback period 8t. Alternatively, the device 120 may transmit non-periodical RS such as DMRS(s) to the device 110. In a further example, the device 120 may transmit the RS(s) to the device 110 at each timeslot.

In some example embodiments, the device 110-1 receives 633 the RS. The device 110-1 may determine CSI based on the RS. For example, the device 110-1 may measure current CSI based on the RS. At a first timeslot, the device 110-1 may measure first CSI based on a first RS received at the first timeslot. At a second timeslot after the feedback period 8t from the first timeslot, the device 110-1 may measure second CSI based on a second RS received at the second timeslot. The first RS and the second RS may be the same or different. Likewise, the device 110-N may receive 636 RS(s) and determine 642 CSI based on the RS(s).

In some example embodiments, the dimension of the CSI for each device 110 may be equal to Nₜ×Nᵣ, where Nₜ denotes the number of antennas at the device 120, and Nᵣ denotes the number of antennas at the device 110. Each dimension of the CSI may comprise a complex value.

Alternatively, the dimension of the CSI may be equal to 2×Nₜ×Nᵣ. In this case, a real part and an imaginary part of the complex value of each dimension of the CSI (or channel matrix) may be separated before fed into the compression model 310.

The device 110-1 may determine 645 message(s) indicating the channel state of the device 110-1 according to the trained compression model 310-1 and based on the determined CSI. For example, the message may be a codeword predefined in a codebook or other suitable vectors. At the first timeslot, the device 110-1 may determine a first message with the large length B₁ according to the trained compression model 310-1 and based on the first CSI. At the second timeslot, the device 110-1 may determine a second message with the short length Bₛ according to the trained compression model 310-1 and based on difference between the second CSI and the first CSI.

In the scenario that the length information further comprises the repeat times of the large/short length, the device 110-1 may determine the first UF_{B1} message(s) with the large length B₁, and determine the following UF_{Bs} message(s) with the short length Bₛ. Similarly, the device 110-N may determine 648 message(s) indicating the channel state of the device 110-N according to the trained compression model 310-N and based on the determined CSI.

The device 110-1 transmits 651 the message to the device 120. For example, the device 110-1 may transmit 651 the message to the device 120 via PUSCH or PUCCH. At the first timeslot, the device 110-1 may transmit the first message with the large length B₁ to the device 120. At the second timeslot, the device 110-1 may transmit the second message with the short length Bₛ to the device 120. In addition, the device 110-1 may also transmit DL rate of the previous period of time to the device 120.

The device 120 receives 654 the message from the device 110-1. The device 120 obtains 657 combined beamforming features for the device 110-1 according to the trained combining model 320-1 and based on the message. For example, at the first timeslot, the device 120 may extract current beamforming features from the first message according to the trained combining model 320-1 and determine the current beamforming features as first combined beamforming features of the device 110-1. The device 120 may also determine the current beamforming features as historical beamforming features of the device 110-1.

At the second timeslot, the device 120 may obtain 657 second combined beamforming features of the device 110-1 according to the trained combining model 320-1 and based on the second message and the historical beamforming features of the device 110-1. The device 120 may also update the historical beamforming features based on the combined beamforming features.

The device 120 generates 666 a beam weight for the device 110-1 according to the trained beamforming model 330 and based on the combined beamforming features. The beam weight may be in a form of a vector or a matrix. The device 120 may determine a first beam weight at the first timeslot according to the trained beamforming model 330 and based on the first combined beamforming features. The device 120 may determine a second beam weight at the second timeslot according to the trained beamforming model 330 and based on the second combined beamforming features. Alternatively, or in addition, the device 120 may generate 666 more than one beam weights for the device 110-1 at each timeslot.

In some example embodiments, the device 110-N may also transmit 660 message(s) to the device 120. The device 120 may receive 663 the message(s) from the device 110-N. Similarly, the device 120 may obtain combined beamforming features of the device 110-N according to the trained combining model 320-N and based on the message(s). In the case of that the device 110-N transmitting 660 the message(s) to the device 120, the device 120 may generate a beam matrix according to the trained beamforming model 330 and based on the combined beamforming features of the device 110-1 and the combined beamforming features of the device 110-N.

The beam matrix may comprise the beam weight for the device 110-1 and the beam weight for the device 110-N. The dimension of the beam matrix may be equal to Nₜ×Nᵣ×S, Nₜ denotes the number of antennas at the device 120, Nᵣ denotes the number of antennas at the device 110, and S denotes the number of independent data streams of total active devices. Each dimension of the beam matrix may comprise a complex value.

Alternatively, the dimension of each beam matrix may be equal to 2×Nₜ×Nᵣ×S. In this case, a real part and an imaginary part of the complex value of each dimension of the beam matrix may be separated.

The device 120 may apply the beam weight for DL transmission. For example, the device 120 may perform 669 a transmission to the device 110-1 via a beam formed with the beam weight for the device 110-1. The device 110-1 may receive 720 the transmission via the beam. For example, at the first timeslot, the device 120 may perform 669 a transmission to the device 110-1 via a first beam formed with the first beam weight. At the second timeslot, the device 120 may perform 669 a transmission to the device 110-1 via a second beam formed with the second beam weight. In the scenario that the device 120 also determine the beam weight for the device 110-N, the device 120 may also perform a transmission to the device 110-N via a beam formed with the beam weight for the device 110-N.

Some example embodiments regarding channel state based beamforming according to the present disclosure have been described. Using the present approach, it enables the network device to generate beam weight(s) according to the trained beamforming model and based on message(s) indicating the channel state and the historical beamforming features of the terminal device. Such approach is beamforming oriented, which does not require the CSI recovery. In addition, such approach directly aiming at the optimized beamforming matrices in a supervised learning is more favorable to enhance the DL MIMO transmission. In addition, such approach considers the historical beamforming features of the terminal device, which will improve the performance especially in mobile scenarios. Moreover, the present disclosure also provides a solution jointly considering a group of devices, thus may be favorite for the MU scenarios.

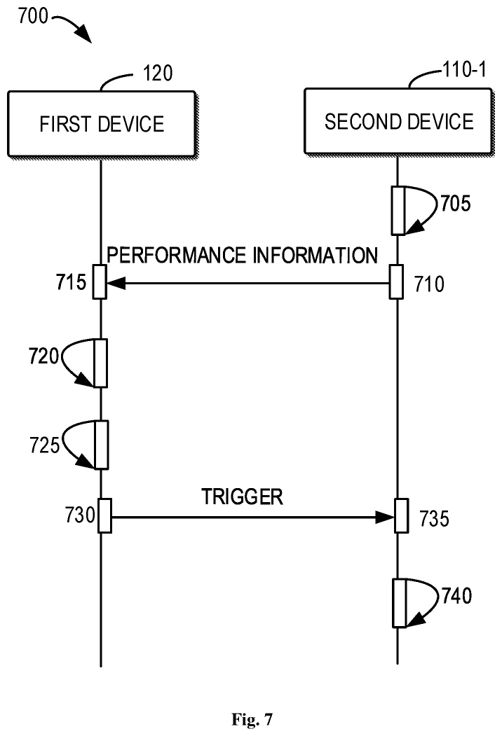

As mentioned above, the compression model 310, the combining model 320 and the beamforming model 330 may be finetuned when applying to the devices. FIG. 7 illustrates a signaling chart 700 showing an example process of finetuning models according to some example embodiments of the present disclosure. For the purpose of discussion, the signaling chart 700 will be described with reference to FIGS. 1 and 3. As shown in FIG. 7, the signaling chart 700 involves the first device (such as the device 120) and the second device (such as the device 110-1). For the purpose of discussion, there are two devices illustrated in FIG. 7. It is to be understood that the signaling chart 700 may involve more devices, and the number of devices illustrated in FIG. 7 is only for the purpose of illustration without suggesting any limitations. For example, the signaling chart 700 may also involve the device 120 and the device 110-N.

In operations, the device 110-1 may determine 705 performance information based on a transmission between the device 110-1 and the device 120. The performance information may indicate the quality of the transmission. For example, the device 110-1 may determine 705 the performance information based on a time delay of the transmission or based on an efficiency of the transmission. The device 110-1 may transmit 710 the performance information to the device 120.

The device 120 may receive 715 the performance information. The device 120 may determine 720 a finetuning indication based on the performance information. For example, if the performance information indicates that the transmission performance is good or normal, then the finetuning indication may indicate not to perform a finetuning. By contrast, if the performance information indicates that the transmission performance is unsatisfying, then the finetuning indication may indicate to perform a finetuning.

In accordance with a determination that the finetuning indication indicates not to perform a finetuning, the device 120 may continue to perform beamforming as shown in FIG. 6. In accordance with a determination that the finetuning indication indicates to perform a finetuning, the device 120 may perform 725 the finetuning for the combining model 320 and the beamforming model 330. For example, the device 120 may perform 725 the finetuning for the combining model 320 and the beamforming model 330 based on the beam weight(s) generated for the device 110 and the received message(s) from the device 110-1 in a previously time period.

In addition, the device 120 may transmit 730 a trigger to the device 110-1. The trigger indicates the device 110-1 to perform a finetuning for the compression model 310. The device 120 may receive 735 the trigger. The device 120 may perform the finetuning for the compression model 310 responsive to the trigger. For example, the device 120 may perform the finetuning based on the beam weight(s) generated for the device-1 110 and the measured CSI in a previously time period.

By using the finetuning process, the performance of the compression model 310, the combining model 320 and the beamforming model 330 will be enhanced. In this way, the device 120 may generate an optimized beam weight for the device 110-1. Thus, the transmission performance between the device 120 and the device 110-1 will be improved. In addition, the signaling overheads will also be reduced.

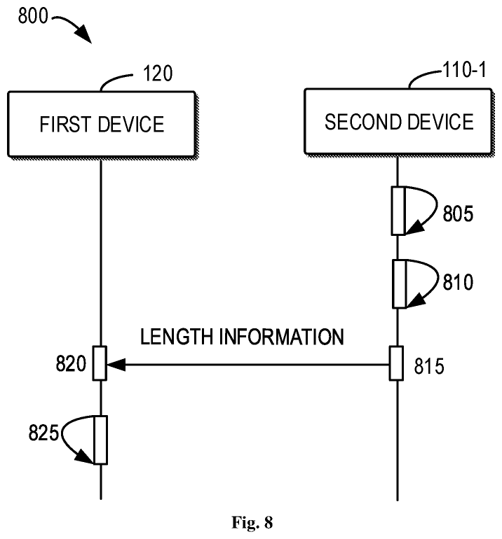

In some example embodiments, the above mentioned large length information may be adjusted during the beamforming process. FIG. 8 illustrates a signaling chart 800 showing an example process of adjusting the length information according to some example embodiments of the present disclosure. For the purpose of discussion, the signaling chart 800 will be described with reference to FIGS. 1 and 3. As shown in FIG. 8, the signaling chart 800 involves the first device (for example, the device 120) and the second device (such as the device 110-1). For the purpose of discussion, there are two devices illustrated in FIG. 8. It is to be understood that the signaling chart 800 may involve more devices, and the number of devices illustrated in FIG. 8 is only for the purpose of illustration without suggesting any limitations. For example, the signaling chart 800 may also involve the device 120 and the device 110-N.

In operations, similar to the signaling chart 700, the device 110-1 may determine 705 performance information based on a transmission between the device 110-1 and the device 120. The performance information may indicate the quality of the transmission. For example, the device 110-1 may determine 705 the performance information based on a time delay of the transmission or based on an efficiency of the transmission. In some example embodiments, the device 110-1 may perform the determination 705 and the determination 605 separately. Alternatively, the determination 705 and the determination 805 may be a same determination.

In accordance with a determination that the performance information indicates the transmission performance is unsatisfying, the device 110-1 may update 810 the length information. For example, if the performance information indicates that the efficiency of transmission is less than a predefined threshold, then the device 110-1 may update the length information by increasing or reducing the short length Bₛ comprised in the length information. Alternatively, or in addition, the device 110-1 may update the length information by adjusting other parameters such as the large length B₁, the repeat times UF_{B1} of the large length or the repeat times UF_{Bs} of the short length.

The device 110-1 may transmit 815 the updated length information to the device 120. The device 120 may receive 820 the updated length information. The device 120 may perform 825 the following beamforming based on the updated length information. In this way, the length of the message(s) may be flexibly adapted. Thus, it will enhance the transmission performance while maintaining reduced overheads.

Several example embodiments regarding channel state based beamforming according to the present disclosure have been described above. Several simulations have been made to compare the channel state based beamforming according to the present disclosure and the conventional channel state based beamforming. In the simulation, the COST2100 channel model is used to generate CSI data. The configuration of the simulation is listed in Table 1 below.

TABLE 1
Simulation parameter setting

| | Parameter | Notation | |
|---|---|---|---|
| Number of total active terminal devices | K | 2 | |
| Number of antennas at network device | Nₜ | 32 | |
| Number of antennas at each terminal device | Nᵣ | 1 | |
| Carrier frequency | f | 5.3 | GHz |
| Interval of timeslot for CSI report | δt | 40 | ms |

| | | |
|---|---|---|
| Sequential message (codeword) | T | 10 |
| Terminal device velocity | ν | 0.001 & 1 m/s |

As shown in Table 1, in the simulation, two terminal devices are assumed to be active in a 20m×20m square coverage area with a network device located in the center. The network device is equipped with a uniform linear array. Each terminal device has a single antenna. Hence, the total number of independent DL data streams is the same as the number of active terminal devices. The number of antennas at the network device is set as Nₜ=32. The feedback periodicity T, and the number of all timeslots are set as 10. The simulation evaluates the performance of the present approach in two scenarios. In the motionless scenario, the speed of the terminal devices is 0.001 m/s. In the motion scenario the speed of the terminal devices is 1 m/s.

For each scenario, three schemes are considered for comparison. In a first scheme also referred as a static beamforming scheme, the active terminal devices only transmit message(s) with a large length B₁ in the first timeslot. The network device maintains the beamforming weights in subsequent T-1 timeslots. In a second scheme also referred to as an independent beamforming scheme, the active terminal devices feedback messages with different lengths (such as B₁ and Bₛ). However, in the independent beamforming scheme, the network device will not store and utilize historical beamforming features of the active terminal devices. In a third scheme also referred to as an adaptive beamforming scheme, the network device may use the channel state based beamforming according to the present disclosure. That is, the active terminal devices feedback messages with different lengths and the network device may store and utilize historical beamforming features of the active terminal devices.

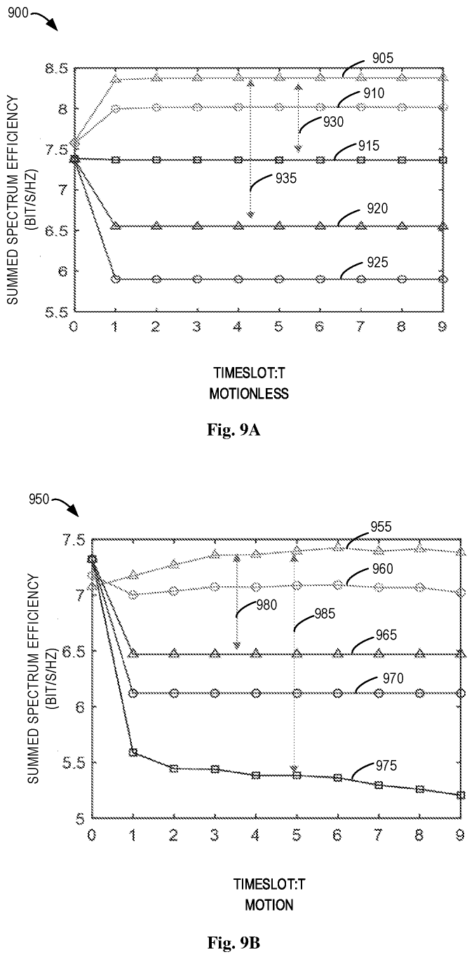

FIG. 9A illustrates a chart 900 illustrating efficiency at different timeslots in different schemes in motionless scenario. In FIG. 9A, a curve 905 represents the summed spectrum efficiency in the third scheme with Bₛ equates to 5. A curve 910 represents the summed spectrum efficiency in the third scheme with Bₛ equates to 3. A curve 915 represents the summed spectrum efficiency in the first (static) scheme. A curve 920 represents the summed spectrum efficiency in the second scheme with Bₛ equates to 5. A curve 925 represents the summed spectrum efficiency in the second scheme with Bₛ equates to 3.

FIG. 9A also illustrates a performance gap 930 shows the performance gap between the adaptive beamforming scheme and the static beamforming scheme which fails to adjust the beamforming weights in the subsequent timeslots. In addition, a performance gap 935 shows the performance gap between the adaptive beamforming scheme and the independent beamforming scheme which fails to consider the correlation in time domain. In the motionless scenario, the CSI varies slowly. From FIG. 9A, it can be seen that using the adaptive beamforming scheme according to the present application, the summed spectrum efficiency will be greatly improved. In addition, it can achieve higher throughput in subsequent timeslots than the initial timeslot with very low feedback overheads.

Similar to FIG. 9A, FIG. 9B illustrates a chart 950 illustrating efficiency at different timeslots in different schemes in motion scenario. In FIG. 9B, a curve 955 represents the summed spectrum efficiency in the third scheme with Bₛ equates to 5. A curve 960 represents the summed spectrum efficiency in the third scheme with Bₛ equates to 3. A curve 965 represents the summed spectrum efficiency in the second scheme with Bₛ equates to 5. A curve 970 represents the summed spectrum efficiency in the second scheme with Bₛ equates to 3. A curve 975 represents the summed spectrum efficiency in the first (static) scheme.

FIG. 9B also illustrates a performance gap 980 shows the performance gap between the adaptive beamforming scheme and the independent beamforming scheme which fails to consider the correlation in time domain. In addition, a performance gap 985 shows the performance gap between the adaptive beamforming scheme and the static beamforming scheme which fails to adjust the beamforming weights in the subsequent timeslots. In the motion scenario, the CSI varies fast. From FIG. 9B, it can be seen that using the adaptive beamforming scheme according to the present application, the summed spectrum efficiency will be greatly improved. The efficiency will be significantly improved than the static beamforming scheme. In addition, it can maintain the throughput as the initial timeslot with very low feedback overheads (3 bits). Moreover, the throughput over subsequent timeslots will outperform the initial timeslot with more feedback (5 bits).

Table 2 shows that averaged throughput of the subsequent timeslot compared with the static and independent beamforming scheme. The gain of the present adaptive beamforming scheme varies from 8.8% to 15.3%.

TABLE 2
Averaged spectral efficiency

| | | Spectral efficiency (bit/s/Hz) | | | |
|---|---|---|---|---|---|
| | | First | Second | Third | |
| ν(m/s) | Bₛ | scheme | scheme | scheme | Gain |
| 0.001 | 3 | 7.37 | 5.90 | 8.01 | 8.8% |
| (motionless) | 5 | | 6.55 | 8.37 | 13.7% |
| 1 | 3 | 5.37 | 6.12 | 7.06 | 15.3% |
| (motion) | 5 | | 6.47 | 7.35 | 9.1% |

As shown in Table 2, the adaptive beamforming scheme according to the present disclosure will provide a higher performance gain than other schemes. From the above discussion, the simulation demonstrates that the proposed approach according to the present disclosure can achieve excellent overall performance gain with reduced overheads by using beamforming oriented optimization to maximum throughputs, adaptive length in feedback by leveraging historical information, and the synergic optimization by beamforming model designed for MU transmission.

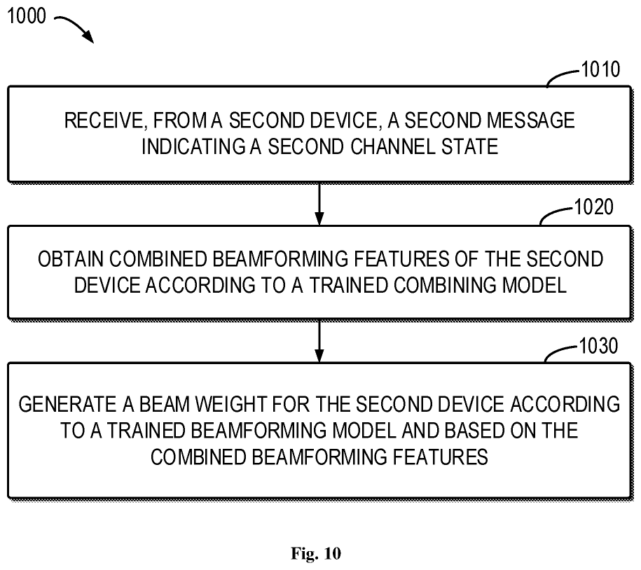

FIG. 10 shows a flowchart of an example method 1000 implemented at a first device (for example, the device 120) in accordance with some example embodiments of the present disclosure. For the purpose of discussion, the method 1000 will be described from the perspective of the device 120 with respect to FIG. 1.

At block 1010, the device 120 receives a second message indicating a second channel state from the device 110-1. A second length of the second message is less than a first length of a first message indicating a first channel state previously received from the device 110-1.

At block 1020, the device 120 obtains combined beamforming features of the device 110-1 according to a trained combining model associated with the device 110-1 and based on the second message and historical beamforming features of the device 110-1.

At block 1030, the device 120 generates a beam weight for the device 110-1 according to a trained beamforming model and based on the combined beamforming features.

In some example embodiments, the historical beamforming features of the device 110-1 are obtained based on the first message.

In some example embodiments, the device 120 may update the historical beamforming features of the device 110-1 based on the second message.

In some example embodiments, the device 120 may transmit reference signal, RS, configuration information to the device 110-1. The RS configuration information comprises a time offset indicating a time interval between the second message and the first message.

In some example embodiments, the device 120 may transmit, to the device 110-1, a reference signal, RS, to be used for determining channel state information, CSI, by the device 110-1.

In some example embodiments, the first message is determined by the device 110-1 according to a trained compression model and based on the first length and first CSI. The first CSI is determined by the device 110-1 based on a first RS received at a first timeslot.

In some example embodiments, the second message is determined by the device 110-1 according to the trained compression model and based on the second length and a difference between second CSI and the first CSI. The second CSI is determined by the device 110-1 based on a second RS received at a second timeslot after the first timeslot.

In some example embodiments, the device 120 may receive from the device 110-N, a third message indicating a third channel state of the device 110-N. The device 120 may obtain historical beamforming features of the device 110-N based on the third message.

The device 120 may receive, from the device 110-N, a fourth message indicating a fourth channel state of the device 110-N. The fourth message has a fourth length less than a third length of the third message. The device 120 may obtain combined beamforming features of the device 110-N according to a further trained combining model associated with the device 110-N and based on the fourth message and the historical beamforming features of the device 110-N.

In some example embodiments, in generating the beam weight for the device 110-1, the device 120 may generate the beam weight for the device 110-1 and a further beam weight for the device 110-N according to the trained beamforming model and based on the combined beamforming features of the device 110-1 and the combined beamforming features of the device 110-N.

In some example embodiments, the device 120 may receive, from the device 110, length information indicating the first length and the second length.

In some example embodiments, the device 120 may transmit, to the device 110, a transmission through a beam formed with the beam weight.

In some example embodiments, the device 120 may receive, from the device 110-1, performance information indicating transmission performance between the device 110-1 and the device 120. The device 120 may determine a finetuning indication based on the performance information.

In some example embodiments, in accordance with a determination that the finetuning indication indicates to perform a finetuning, the device 120 may transmit, to the device 110-1, a trigger indicating to perform a finetuning for a trained compression model of the device 110-1; and perform a finetuning for the trained combining model and the trained beamforming model.

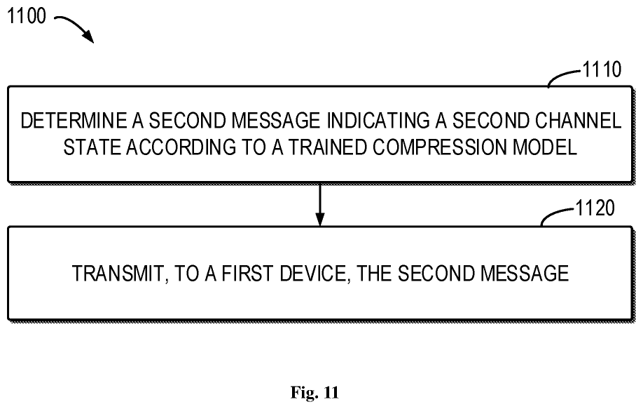

FIG. 11 shows a flowchart of an example method 1100 implemented at a second device (for example, the device 110-1) in accordance with some example embodiments of the present disclosure. For the purpose of discussion, the method 1100 will be described from the perspective of the device 110-1 with respect to FIG. 1.

At block 1110, the device 110-1 determines a second message indicating a second channel state according to a trained compression model. The second message has a second length less than a first length of a first message indicating a first channel state. The first message is previously determined by the device 110-1. At block 1120, the device 110-1 transmits the second message to the device 120.

In some example embodiments, the device 110-1 may receive, from the device 120, reference signal, RS configuration information. The RS configuration information comprises a time offset indicating a time interval between the second message and the first message.

In some example embodiments, the device 110-1 may receive, from the device 120, a first reference signal, RS at a first timeslot. The device 110-1 may determine first channel state information, CSI, based on the first RS. The device 110-1 may further determine the first message according to the trained compression model and based on the first CSI.

In some example embodiments, the device 110-1 may receive, from the device 120, a second RS at a second timeslot after the first timeslot. The device 110 may determine second CSI based on the second reference signal. In determining the second message, the device 110-1 may determine the second message according to the trained compression model and based on a difference between the second CSI and the first CSI.

In some example embodiments, the device 110-1 transmits, to the device 120, length information indicating the first length and the second length.

In some example embodiments, the device 110-1 may receive, from the device 120, a transmission through a beam formed with the beam weight.

In some example embodiments, the device 110-1 may determine performance information based on a transmission between the device 120 and the device 110-1. The device 110-1 may transmit, to the device 120, the performance information.

In some example embodiments, in accordance with a determination to update the first length and the second length, the determination being based on the performance information, the device 110-1 may update the length information based on the performance information.

In some example embodiments, the device 110-1 may receive, from the device 120, a trigger indicating to perform a finetuning for the trained compression model. The device 110-1 may perform the finetuning for the trained compression model.

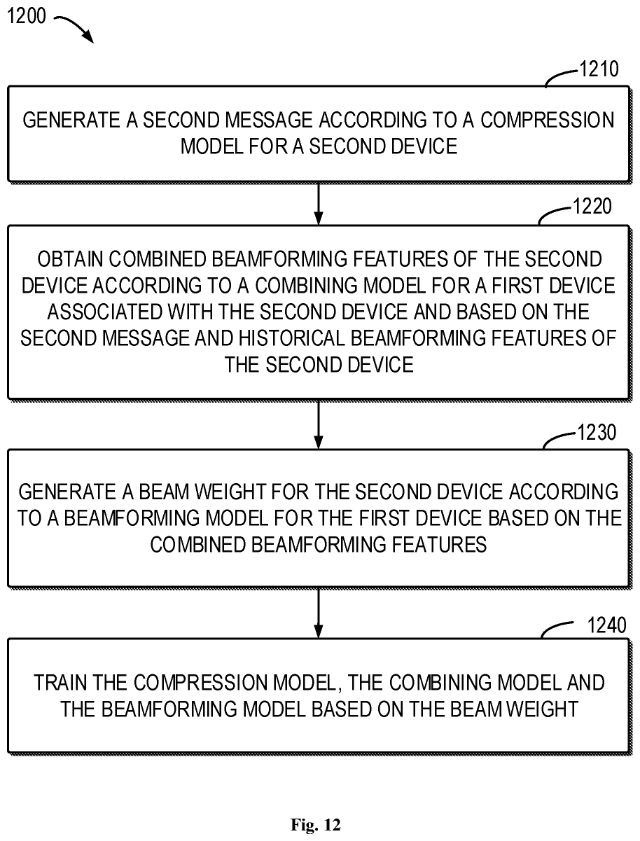

FIG. 12 shows a flowchart of an example method 1200 implemented at a fourth device in accordance with some example embodiments of the present disclosure. The fourth device may be a computing device, an electronic device or other suitable devices.

At block 1210, the fourth device generates a second message according to a compression model for a device 110-1. The second message indicates a second channel state. The second message has a second length less than a first length of a first message generated previously. The first message indicates a first channel state;

At block 1220, the fourth device obtains combined beamforming features of the device 110-1 according to a combining model for the device 120 associated with the device 110-1 and based on the second message and historical beamforming features of the device 110-1.

At block 1230, the fourth device generates a beam weight for the device 110-1 according to a beamforming model for the device 120 based on the combined beamforming features.

At block 1240, the fourth device trains the compression model, the combining model and the beamforming model based on the beam weight generated as block 1230.

In some example embodiments, the fourth device may receive first channel state information, CSI. The fourth device may receive second CSI since a time interval after the first CSI. In generating the second message, the fourth device may generate the second message according to the compression model and based on a difference between the second CSI and the first CSI.

In some example embodiments, in training the compression model, the combining model and the beamforming model, the fourth device may determine beamforming gain for the device 110-1 based on the beam weight and the second CSI; determine interference between the device 110-1 and the device 110-N communicating with the device 120 based at least on a further beam weight for the device 110-N and the second CSI; and determine parameters of the compression model, the combining model and the beamforming model based on a comparison between the beamforming gain and the interference.

In some example embodiments, the historical beamforming features are obtained based on the first message. In some example embodiments, the fourth device may update the historical beamforming features based on the second message.

In some example embodiments, the fourth device may generate a fourth message of the device 110-N according to a second compression model for the device 110-N. The fourth message indicates a fourth channel state of the device 110-N. The fourth message has a fourth length less than a third length of a third message generated previously. The third message indicates a third channel state of the device 110-N. The fourth device may obtain combined beamforming features of the device 110-N according to a further combining model for the device 120 associated with the device 110-N and based on the fourth message and historical beamforming features of the device 110-N. The fourth device may generate a further beam weight for the device 110-N according to the beamforming model for the device 120 based on the combined beamforming features of the device 110-N.

In some example embodiments, in training the compression model, the combining model and the beamforming model, the fourth device may train the compression model, the combining model and the beamforming model based on the beam weight and the further beam weight.

In some example embodiments, a first apparatus capable of performing any of the method 1000 (for example, the device 120) may comprise means for performing the respective operations of the method 1000. The means may be implemented in any suitable form. For example, the means may be implemented in a circuitry or software module. The first apparatus may be implemented as or included in the device 120.

In some example embodiments, the first apparatus comprises: means for receiving a second message indicating a second channel state from a second apparatus. A second length of the second message is less than a first length of a first message indicating a first channel state previously received from the second apparatus.

In some example embodiments, the first apparatus further comprises: means for obtaining combined beamforming features of the second apparatus according to a trained combining model associated with the second apparatus and based on the second message and historical beamforming features of the second apparatus.

In some example embodiments, the first apparatus further comprises: means for generating a beam weight for the second apparatus according to a trained beamforming model and based on the combined beamforming features.

In some example embodiments, the historical beamforming features of the second device are obtained based on the first message.

In some example embodiments, the first apparatus further comprises: means for updating the historical beamforming features of the second apparatus based on the second message.

In some example embodiments, the first apparatus further comprises: means for transmitting reference signal, RS, configuration information to the second apparatus. The RS configuration information comprises a time offset indicating a time interval between the second message and the first message.

In some example embodiments, the first apparatus further comprises: means for transmitting, to the second apparatus, a reference signal, RS, to be used for determining channel state information, CSI, by the second apparatus.

In some example embodiments, the first message is determined by the second apparatus according to a trained compression model and based on the first length and first CSI. The first CSI is determined by the second apparatus based on a first RS received at a first timeslot.

In some example embodiments, the second message is determined by the second apparatus according to the trained compression model and based on the second length and a difference between second CSI and the first CSI. The second CSI is determined by the second apparatus based on a second RS received at a second timeslot after the first timeslot.

In some example embodiments, the first apparatus further comprises: means for receiving from a third apparatus, a third message indicating a third channel state of the third apparatus. The first apparatus further comprises: means for obtaining historical beamforming features of the third apparatus based on the third message. The first apparatus further comprises: means for receiving, from the third apparatus, a fourth message indicating a fourth channel state of the third device. The fourth message has a fourth length less than a third length of the third message. The first apparatus further comprises: means for obtaining combined beamforming features of the third apparatus according to a further trained combining model associated with the third apparatus and based on the fourth message and the historical beamforming features of the third apparatus.

In some example embodiments, in generating the beam weight for the second apparatus, the first apparatus further comprises: means for generating the beam weight for the second apparatus and a further beam weight for the third apparatus according to the trained beamforming model and based on the combined beamforming features of the second apparatus and the combined beamforming features of the third apparatus.

In some example embodiments, the first apparatus further comprises: means for receiving, from the second apparatus, length information indicating the first length and the second length.

In some example embodiments, the first apparatus further comprises: means for transmitting, to the second apparatus, a transmission through a beam formed with the beam weight.

In some example embodiments, the first apparatus further comprises: means for receiving, from the second apparatus, performance information indicating transmission performance between the second apparatus and the first apparatus. The first apparatus further comprises: means for determining a finetuning indication based on the performance information.

In some example embodiments, in accordance with a determination that the finetuning indication indicates to perform a finetuning, the first apparatus further comprises: means for transmitting, to the second apparatus, a trigger indicating to perform a finetuning for a trained compression model of the second apparatus; and means for performing a finetuning for the trained combining model and the trained beamforming model.

In some example embodiments, a second apparatus capable of performing any of the method 1100 (for example, the device 110-1) may comprise means for performing the respective operations of the method 1100. The means may be implemented in any suitable form. For example, the means may be implemented in a circuitry or software module. The second apparatus may be implemented as or included in the device 110.

In some example embodiments, the second apparatus comprises: means for determining a second message indicating a second channel state according to a trained compression model. The second message has a second length less than a first length of a first message indicating a first channel state. The first message is previously determined by the second apparatus. In some example embodiments, the second apparatus further comprises: means for transmitting the second message to a first apparatus.

In some example embodiments, the second apparatus further comprises means for receiving, from the first apparatus, reference signal, RS, configuration information. The RS configuration information comprises a time offset indicating a time interval between the second message and the first message. The second apparatus further comprises means for receiving, from the first apparatus, a first reference signal. The second apparatus further comprises means for receiving, from the first apparatus, a second reference signal after the time interval since receiving the first reference signal.

In some example embodiments, the second apparatus further comprises means for receiving, from the first apparatus, a first reference signal, RS at a first timeslot. The second apparatus further comprises means for determining first channel state information, CSI, based on the first RS. The second apparatus further comprises means for determining the first message according to the trained compression model and based on the first CSI.

In some example embodiments, the second apparatus further comprises means for receiving, from the first apparatus, a second RS at a second timeslot after the first timeslot. The second apparatus further comprises means for determining second CSI based on the second reference signal. In determining the second message, the second apparatus further comprises means for determining the second message according to the trained compression model and based on a difference between the second CSI and the first CSI.

In some example embodiments, the second apparatus further comprises means for transmitting, to the first apparatus, length information indicating the first length and the second length.

In some example embodiments, the second apparatus further comprises means for receiving, from the first apparatus, a transmission through a beam formed with the beam weight.

In some example embodiments, the second apparatus further comprises means for determining performance information based on a transmission between the first apparatus and the second apparatus. The second apparatus further comprises means for transmitting, to the first apparatus, the performance information.

In some example embodiments, in accordance with a determination to update the first length and the second length, the determination being based on the performance information, the second apparatus comprises means for updating the length information based on the performance information.

In some example embodiments, the second apparatus further comprises means for receiving, from the first apparatus, a trigger indicating to perform a finetuning for the trained compression model. The second apparatus further comprises means for performing the finetuning for the trained compression model.

In some example embodiments, a fourth apparatus capable of performing any of the method 1200 may comprise means for performing the respective operations of the method 1200. The means may be implemented in any suitable form. For example, the means may be implemented in a circuitry or software module.

In some example embodiments, the fourth apparatus comprises: means for generating a second message according to a compression model for a second apparatus. The second message indicates a second channel state. The second message has a second length less than a first length of a first message generated previously. The first message indicates a first channel state;

In some example embodiments, the fourth apparatus further comprises: means for obtaining combined beamforming features of the second apparatus according to a combining model for a first apparatus associated with the second apparatus and based on the second message and historical beamforming features of the second apparatus.

In some example embodiments, the fourth apparatus further comprises: means for generating a beam weight for the second apparatus according to a beamforming model for the first apparatus based on the combined beamforming features.

In some example embodiments, the fourth apparatus further comprises: means for training the compression model, the combining model and the beamforming model based on the beam weight.

In some example embodiments, the fourth apparatus further comprises: means for receiving first channel state information, CSI. The fourth apparatus further comprises: means for receiving second CSI since a time interval after the first CSI. In generating the second message, the fourth apparatus comprises: means for generating the second message according to the compression model and based on a difference between the second CSI and the first CSI.

In some example embodiments, in training the compression model, the combining model and the beamforming model, the fourth apparatus further comprises: means for determining beamforming gain for the second apparatus based on the beam weight and the second CSI; means for determining interference between the second apparatus and a third apparatus communicating with the first apparatus based at least on a further beam weight for the third apparatus and the second CSI; and means for determining parameters of the compression model, the combining model and the beamforming model based on a comparison between the beamforming gain and the interference.

In some example embodiments, the historical beamforming features are obtained based on the first message. In some example embodiments, the fourth apparatus further comprises: means for updating the historical beamforming features based on the second message.

In some example embodiments, fourth apparatus further comprises: means for generating a fourth message of a third apparatus according to a second compression model for the third apparatus. The fourth message indicates a fourth channel state of the third apparatus. The fourth message has a fourth length less than a third length of a third message generated previously. The third message indicates a third channel state of the third apparatus. The fourth apparatus further comprises: means for obtaining combined beamforming features of the third apparatus according to a further combining model for the first apparatus associated with the third apparatus and based on the fourth message and historical beamforming features of the third apparatus. The fourth apparatus further comprises: means for generating a further beam weight for the third apparatus according to the beamforming model for the first apparatus based on the combined beamforming features of the third apparatus.

In some example embodiments, in training the compression model, the combining model and the beamforming model, the fourth apparatus further comprises: means for training the compression model, the combining model and the beamforming model based on the beam weight and the further beam weight.

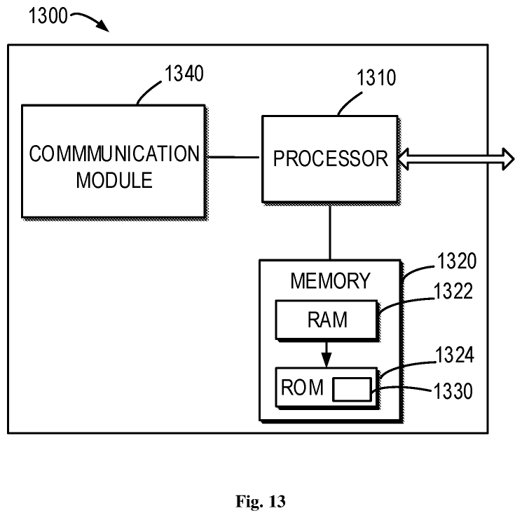

FIG. 13 is a simplified block diagram of a device 1300 that is suitable for implementing example embodiments of the present disclosure. The device 1300 may be provided to implement a communication device, for example, the device 110 or the device 120 as shown in FIG. 1. As shown, the device 1300 includes one or more processors 1310, one or more memories 1320 coupled to the processor 1310, and one or more communication modules 1340 coupled to the processor 1310.

The communication module 1340 is for bidirectional communications. The communication module 1340 has one or more communication interfaces to facilitate communication with one or more other modules or devices. The communication interfaces may represent any interface that is necessary for communication with other network elements. In some example embodiments, the communication module 1340 may include at least one antenna.

The processor 1310 may be of any type suitable to the local technical network and may include one or more of the following: general purpose computers, special purpose computers, microprocessors, digital signal processors (DSPs) and processors based on multicore processor architecture, as non-limiting examples. The device 1300 may have multiple processors, such as an application specific integrated circuit chip that is slaved in time to a clock which synchronizes the main processor.

The memory 1320 may include one or more non-volatile memories and one or more volatile memories. Examples of the non-volatile memories include, but are not limited to, a Read Only Memory (ROM) 1324, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 922 and other volatile memories that will not last in the power-down duration.

A computer program 1330 includes computer executable instructions that are executed by the associated processor 1310. The program 1330 may be stored in the memory, e.g., ROM 1324. The processor 1310 may perform any suitable actions and processing by loading the program 1330 into the RAM 1322.

The example embodiments of the present disclosure may be implemented by means of the program 1330 so that the device 1300 may perform any process of the disclosure as discussed with reference to FIGS. 3 to 12. The example embodiments of the present disclosure may also be implemented by hardware or by a combination of software and hardware.

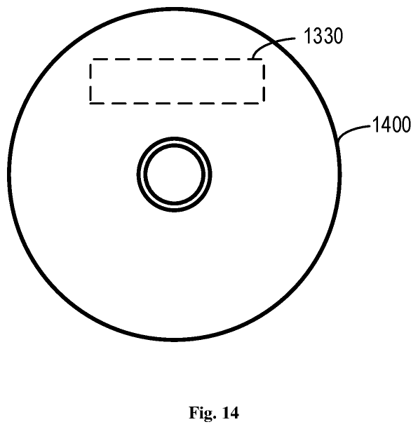

In some example embodiments, the program 1330 may be tangibly contained in a computer readable medium which may be included in the device 1300 (such as in the memory 1320) or other storage devices that are accessible by the device 1300. The device 1300 may load the program 1330 from the computer readable medium to the RAM 1322 for execution. The computer readable medium may include any types of tangible non-volatile storage, such as ROM, EPROM, a flash memory, a hard disk, CD, DVD, and the like. FIG. 14 shows an example of the computer readable medium 1400 which may be in form of CD, DVD or other optical storage disk. The computer readable medium has the program 1330 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target physical or virtual processor, to carry out any of the methods as described above with reference to FIGS. 10-12. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device, comprising:
at least one processor; and
at least one memory
storing instructions that, when executed with the at least one processor, cause the first device to:
receive, from a second device, a second message indicating a second channel state, a second length of the second message being less than a first length of a first message indicating a first channel state previously received from the second device;
obtain combined beamforming features of the second device according to a trained combining model associated with the second device and based on the second message and historical beamforming features of the second device; and
generate a beam weight for the second device according to a trained beamforming model and based on the combined beamforming features.

2. The first device of claim 1, wherein the historical beamforming features of the second device are obtained based on the first message.

3. The first device of claim 1, wherein the instructions, when executed with the at least one processor, further cause the first device to:
update the historical beamforming features of the second device based on the second message.

4. (canceled)

5. The first device of claim 1, wherein the instructions, when executed with the at least one processor, further cause the first device to:
transmit, to the second device, a reference signal to be used for determining channel state information; with the second device.

6. The first device of claim 5, wherein the instructions, when executed with the at least one processor, determine the first message with the second device according to a trained compression model and based on the first length and first channel state information, the first channel state information being determined with the second device based on a first reference signal received at a first timeslot.

7. The first device of claim 6, wherein the instructions, when executed with the at least one processor, determine the second message with the second device according to the trained compression model and based on the second length and a difference between second channel state information and the first channel state information, the second channel state information being determined with the second device based on a second reference signal received at a second timeslot after the first timeslot.

8. The first device of claim 1, wherein the instructions, when executed with the at least one processor, further cause the first device to:
receive, from a third device, a third message indicating a third channel state of the third device;
obtain historical beamforming features of the third device based on the third message;
receive, from the third device, a fourth message indicating a fourth channel state of the third device, the fourth message having a fourth length less than a third length of the third message; and
obtain combined beamforming features of the third device according to a further trained combining model associated with the third device and based on the fourth message and the historical beamforming features of the third device.

9. The first device of claim 8, wherein the instructions, when executed with the at least one processor, cause the apparatus to generate the beam weight for the second device and a further beam weight for the third device according to the trained beamforming model and based on the combined beamforming features of the second device and the combined beamforming features of the third device.

10-11. (canceled)

12. The first device of claim 1, wherein the instructions, when executed with the at least one processor cause the first device to:
receive, from the second device, performance information indicating transmission performance between the second device and the first device; and
determine a finetuning indication based on the performance information.

13. The first device of claim 12, wherein the instructions, when executed with the at least one processor, further cause the first device to:
in accordance with a determination that the finetuning indication indicates to perform a finetuning,
transmit, to the second device, a trigger indicating to perform a finetuning for a trained compression model of the second device; and
perform a finetuning for the trained combining model and the trained beamforming model.

14. A second device, comprising:
at least one processor; and
at least one memory
storing instructions that, when executed with the at least one processor, cause the second device to:
determine a second message indicating a second channel state according to a trained compression model, the second message having a second length less than a first length of a first message indicating a first channel state, the first message being previously determined with the second device; and
transmit, to a first device, the second message.

15. The second device of claim 14, wherein the instructions, when executed with the at least one processor, further cause the second device to:
receive, from the first device, reference signal configuration information, the reference signal configuration information comprising a time offset indicating a time interval between the second message and the first message.

16. The second device of claim 14, wherein the instructions, when executed with the at least one processor, further cause the second device to:
receive, from the first device, a first reference signal at a first timeslot;
determine first channel state information based on the first reference signal; and
determine the first message according to the trained compression model and based on the first channel state information.

17. The second device of claim 16, wherein the instructions, when executed with the at least one processor, further cause the second device to:
receive, from the first device, a second reference signal at a second timeslot after the first timeslot; and
determine second channel state information based on the second reference signal;
wherein determining the second message comprises:
determining the second message according to the trained compression model and based on a difference between the second [CSI] channel state information and the first channel state information.

18-29. (canceled)

30. A method, comprising:
receiving, with a first device and from a second device, a second message indicating a second channel state, a second length of the second message being less than a first length of a first message indicating a first channel state previously received from the second device;
obtaining combined beamforming features of the second device according to a trained combining model associated with the second device and based on the second message and historical beamforming features of the second device; and
generating a beam weight for the second device according to a trained beamforming model and based on the combined beamforming features.

31. The method of claim 30, wherein the historical beamforming features of the second device are obtained based on the first message.

32. The method of claim 30, further comprising:
updating the historical beamforming features of the second device based on the second message.

33. The method of claim 30, further comprising:
transmitting, to the second device, reference signal configuration information, the reference signal configuration information comprising a time offset indicating a time interval between the second message and the first message.

34. The method of claim 30, further comprising:
transmitting, to the second device, a reference signal to be used for determining channel state information with the second device.

35-61. (canceled)

62. A non-transitory program storage device readable with an apparatus, tangibly embodying a program of instructions executable with the apparatus for causing an apparatus to perform at least the method of claim 30.
